(19) United States
(12) Patent Application Publication
(10) Pub. No.: US 2026/0071570 A1
(43) Pub. Date: Mar. 12, 2026

(54) INTERNAL COMBUSTION ENGINES AND CYLINDER HEADS CONFIGURED FOR IN-CYLINDER PRESSURE SENSORS

(71) Applicant: Cummins Inc., Columbus, IN (US)

(72) Inventors: Thomas Nathan Fawcett, Leicester (GB); Simon Anthony Burge, Rugby (GB); Matthew W. Isaacs, Summerville, SC (US); Dixon Malcolm Correa, Columbus, IN (US); Axel O. zur Loye, Battle Ground, WA (US); Jonathan W. Georgas, Charleston, SC (US)

(21) Appl. No.: 19/308,603

(22) Filed: Aug. 25, 2025

Related U.S. Application Data
(60) Provisional application No. 63/691,639, filed on Sep. 6, 2024.
(60) Provisional application No. 63/783,370, filed on Apr. 4, 2025.

(51) Int. Cl. F02B 77/08; F01L 3/22; F02F 1/24

(52) U.S. Cl. CPC F02B 77/085; F01L 3/22; F02F 1/24

(57) ABSTRACT

An internal combustion engine includes a cylinder head configured for a cylinder of the internal combustion engine. The cylinder head includes a sensor port with a housing portion configured to house an in-cylinder pressure sensor. The sensor port includes a passage portion that extends from the housing portion to a combustion side of the cylinder head to fluidly connect the in-cylinder pressure sensor with the combustion chamber.

### CROSS-REFERENCE TO RELATED APPLICATIONS:

The present application claims priority to, and the benefit of the filing date of, U.S. Provisional Application Ser. No. 63/691,639 filed Sep. 6, 2024, and U.S. Provisional Application Ser. No. 63/783,370 filed Apr. 4, 2025, each of which is incorporated herein by reference in its entirety.

### TECHNICAL FIELD

This invention relates to internal combustion engines and, more particularly, to internal combustion engines and cylinder heads configured for in-cylinder pressure sensors.

### BACKGROUND

An internal combustion engine may include a cylinder head mounted to an engine block. The engine block defines multiple cylinders that each form a combustion chamber with the cylinder to receive fuel and a charge flow (air or air-fuel mixture) through one or more intake valve openings of the cylinder head such as for a four-stroke engine, or through ports of a cylinder liner such as for a two-stroke engine. The fuel and charge flow are combusted in the combustion chamber in order to drive a piston located in the cylinder.

In-cylinder pressure sensors can be used to measure the pressure variations within the combustion chamber during the combustion cycle. This data can be used to calculate many parameters for controlling engine operation. Existing approaches for installation of in-cylinder pressure sensors suffer from a number of drawbacks and disadvantages with respect to ease of manufacture, reliability, ability to accurately sense in-cylinder pressure conditions, accessibility for maintenance and service of the sensor and nearby engine components, compatibility across various engine platforms, and/or compatibility with different types of in-cylinder pressure sensors. Therefore, further improvements in this technological area are desired.

### SUMMARY

The present disclosure relates to internal combustion engines and cylinder heads that are configured to receive in-cylinder pressure sensors that sense and measure pressure variations in combustion chambers of the internal combustion engine. The sensor port is configured to house the in-cylinder pressure sensor and fluidly connect the in-cylinder pressure sensor and the combustion chamber.

In an embodiment of the present disclosure, an internal combustion engine is configured for in-cylinder pressure sensing. The internal combustion engine includes at least one cylinder including a combustion chamber for receiving a charge flow and fuel for combustion in the combustion chamber. The internal combustion engine also includes a cylinder head mounted to the at least one cylinder. The cylinder head include an opening to provide the charge flow to the combustion chamber through the opening or receive exhaust flow from the combustion chamber. The cylinder head also include a valve relief cut extending around the opening and a sensor port for housing an in-cylinder pressure sensor in fluid communication with the combustion chamber.

In one embodiment, the sensor port includes a housing portion for housing the in-cylinder pressure sensor and a passage portion that extends from the valve relief cut to the housing portion to fluidly connect the in-cylinder pressure sensor housed in the housing portion with the combustion chamber. In another embodiment, the sensor port includes a housing portion for housing the in-cylinder pressure sensor and a passage portion that extends from the cylinder to the housing portion to fluidly connect the in-cylinder pressure sensor housed in the housing portion with the combustion chamber.

In an embodiment, a cylinder head for a cylinder of an internal combustion engine is provided. The cylinder head includes a cylinder head body that includes a combustion side toward the cylinder. The cylinder head body further includes a sensor port. The sensor port includes a housing portion configured to house an in-cylinder pressure sensor, a first passage portion that extends from the housing portion into the cylinder head body, and at least one second passage portion that extends noncollinearly to the first passage portion to the combustion side of the cylinder head.

In an embodiment, a cylinder head for a cylinder of an internal combustion engine is provided. The cylinder head includes a cylinder head body that includes a combustion side toward the cylinder. The cylinder head body further includes a sensor port for an in-cylinder pressure sensor. The sensor port includes a housing portion configured to house the in-cylinder pressure sensor and a passage portion that extends from the housing portion to the combustion side of the cylinder head. The passage portion is configured to attenuate acoustic ringing detected by the in-cylinder pressure sensor caused by resonance in the passage portion, and/or to increase the resonance frequency.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic diagram of an internal combustion engine including cylinder heads and in-cylinder pressure sensors according to one embodiment of the present disclosure.

FIG. 2 is a schematic section view through a cylinder head and cylinder of the internal combustion engine of FIG. 1 showing a sensor port for housing an in-cylinder pressure sensor according to an embodiment of the present disclosure.

FIG. 3 is another schematic section view through the cylinder head of the internal combustion engine of FIG. 1 showing the sensor port and an intake valve.

FIG. 4 is a schematic elevation view of part of an intake manifold mountable to a cylinder head of the internal combustion engine of FIG. 1 according to an embodiment of the present disclosure.

FIG. 5 is a schematic elevation view of part of an intake manifold gasket mountable between a cylinder head of the internal combustion engine of FIG. 1 and the intake manifold of FIG. 4 according to an embodiment of the present disclosure.

FIG. 6 is a schematic elevation view of a part of another embodiment intake manifold gasket.

FIG. 7 is a schematic section view further showing the sensor port and valve relief cut.

FIG. 8 is another schematic section view through the cylinder head of the internal combustion engine of FIG. 1 showing another embodiment sensor port.

FIG. 9 is another schematic section view through the cylinder head of the internal combustion engine of FIG. 1 showing another embodiment sensor port.

FIG. 10 is another schematic section view through the cylinder head of the internal combustion engine of FIG. 1 showing another embodiment sensor port.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

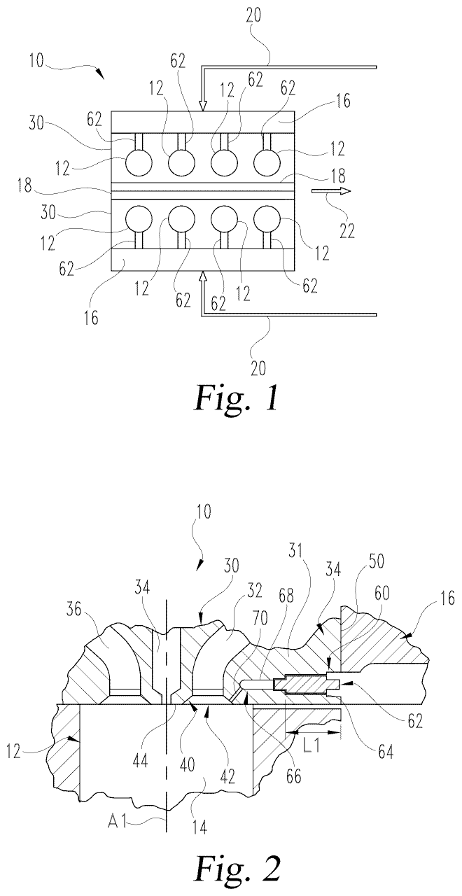

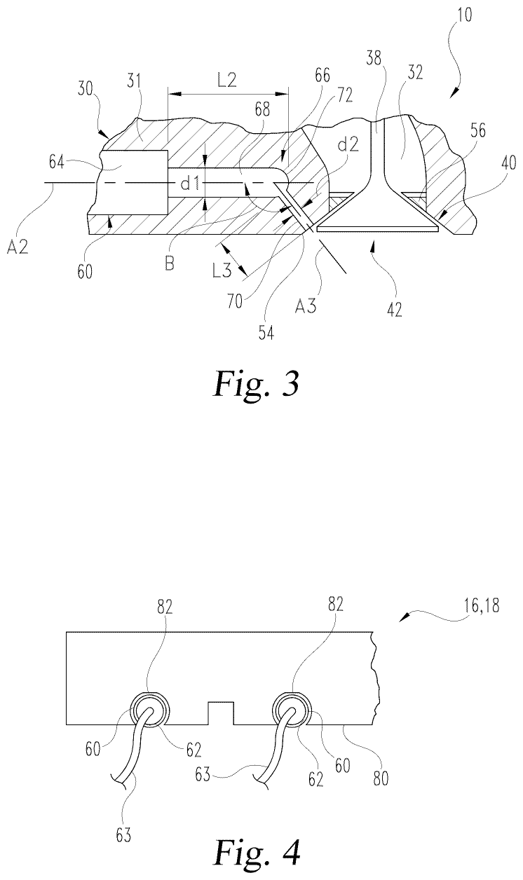

With reference to FIGS. 1-7, an internal combustion engine 10 is configured for in-cylinder pressure sensing. Internal combustion engine 10 includes at least one cylinder 12 including a combustion chamber 14 for receiving a charge flow 20 and fuel for combustion. Internal combustion engine 10 also includes a cylinder head 30 mounted to the at least one cylinder 12.

Sensor ports 60, 160, 160′ are disclosed herein that are configured to house an in-cylinder pressure sensor 62 and fluidly connect the in-cylinder pressure sensor 62 and the combustion chamber 14. The sensor ports 60, 160, 160′ include a housing portion 64, 164 for housing the in-cylinder pressure sensor 62 and a passage portion 66, 166, 166′ that fluidly connects the combustion chamber 14 to the housing portion 64, 164. The in-cylinder pressure sensor 62 measures the pressure in the passage portion 66, 166, 166′ which provides an indication of the pressure in combustion chamber 14.

The pressure in the combustion chamber 14 differs from the pressure in passage portions 66, 166, 166′. This is due to the resonance in passage portions 66, 166, 166′ of the sensor ports 60, 160, 160′ that causes acoustic ringing or oscillations. Passages portions 66, 166, 166′ are configured to attenuate the acoustic ringing detected by in-cylinder pressure sensor 62 and increase resonance frequency so that measurements of pressure in passage portions 66, 166, 166′ by in-cylinder pressure sensor 62 provides an indication of the in-cylinder pressure in combustion chamber 14.

Passage portions 66, 166, 166′ differentiate the acoustic frequency of the passage portion 66, 166, 166′ from the signals detected by in-cylinder pressure sensor 62. Passage portions 66, 166, 166′ are configured so the amplitude of the pressure oscillations in the passage portions 66, 166, 166′ is low enough and the natural frequency of the pressure oscillations in passage portions 66, 166, 166′ is high enough to not interfere with the ability to measure frequencies indicative of combustion performance, such as knock, non-knock combustion, etc.

In an embodiment, cylinder head 30 includes an opening 42 to provide charge flow 20 to combustion chamber 14 through opening 42 or receive exhaust flow from the combustion chamber 14. Cylinder head 30 also includes a valve relief cut 54 extending around opening 42 and a sensor port 60 for housing an in-cylinder pressure sensor 62 in fluid communication with combustion chamber 14. Sensor port 60 includes a housing portion 64 for housing in-cylinder pressure sensor 62 and a passage portion 66 that extends from valve relief cut 54 to housing portion 64 to fluidly connect in-cylinder pressure sensor 62 housed in housing portion 64 with combustion chamber 14.

In an embodiment, cylinder head 30 is provided for cylinder 12 of internal combustion engine 10. Cylinder head 30 includes a cylinder head body 31 that includes a combustion side 44 toward cylinder 12. Cylinder head body 31 further includes sensor port 60 for housing in-cylinder pressure sensor 62. Sensor port 60 includes housing portion 64 configured to house in-cylinder pressure sensor 62, a first passage portion 68 that extends from housing portion 64 into cylinder head 30, and at least one second passage portion 70 that extends noncollinearly to first passage portion 68 to a combustion side 44 of cylinder head 30.

In an embodiment, cylinder head 30 is provided for cylinder 12 of internal combustion engine 10. Cylinder head 30 includes cylinder head body 31 that includes combustion side 44 toward cylinder 12. Cylinder head body 31 further includes a sensor port 160, 160′ for in-cylinder pressure sensor 62. Sensor port 160, 160′ includes a housing portion 164 configured to house in-cylinder pressure sensor 62 and a passage portion 166, 166′ that extends from housing portion 164 to combustion side 44 of cylinder head 30. Passage portion 166, 166′ is configured to attenuate acoustic frequency that is caused by resonance in passage portion 166, 166′ and/or increase resonance frequency

FIGS. 1-7 show various aspects of internal combustion engine 10. Internal combustion engine 10 includes a plurality of cylinders 12 each having a combustion chamber 14. Each combustion chamber 14 defines a longitudinal axis A1 along which a piston (not shown) reciprocates between bottom-dead-center and top-dead-center positions. Cylinder heads 30 extend along one or more of the cylinders 12 and are each connected to intake manifold 16. In an embodiment, cylinder heads 30 are configured to admit a charge flow 20 into combustion chambers 14 and receive an exhaust flow from combustion chambers 14. In other embodiments, intake ports and/or exhaust ports are provided through liners along cylinders 12.

In the illustrated embodiment, cylinder heads 30 each include at least one intake port 32 aligned with a corresponding one of the combustion chambers 14. Each intake port 32 forms opening 42 that is configured to admit charge flow 20 into the connected combustion chamber 14 when the intake valve 38 is displaced from valve seat 40 to an open position. Cylinder heads 30 each include at least one exhaust port 36 connected to combustion chamber 14 that is configured to allow the escape of the combustion products from combustion chamber 14. Cylinder heads 30 are connected to exhaust manifolds 18 that receive the exhaust gases from combustion chambers 14 and provide an exhaust flow 22. Cylinder head 30 may also include a fuel injector port 34 and a fuel injector (not shown) housed in fuel injector port 34, and an igniter port (not shown) for housing an igniter.

Engine 10 can be any type of engine, and in one specific embodiment is a combustion engine that combusts any suitable fuel and includes a number of cylinders 12 each housing a piston. In specific embodiments, engine 10 combusts liquid fuels such as diesel, gaseous fuels such as natural gas, or any other suitable type of fuel. Engine 10 may be a dual fuel engine capable of using more than one type of fuel at a time, or a mono-fuel engine. In the illustrated embodiment, engine 10 includes eight cylinders 12 connected with cylinder heads 30. However, any number of cylinders 12 capable of being used for an engine 10 is contemplated. Engine 10 can be a dual cylinder bank as shown in the illustrated embodiment, an in-line type engine with a single cylinder bank, or other configuration including V-shaped cylinder arrangements, a W-type engine, or any engine arrangement with one or more cylinders 12. It is contemplated that engine 10 can be provided as part of a powertrain for operating equipment (not shown), although other applications are also contemplated and not precluded, such as for gensets, vehicles, and marine applications.

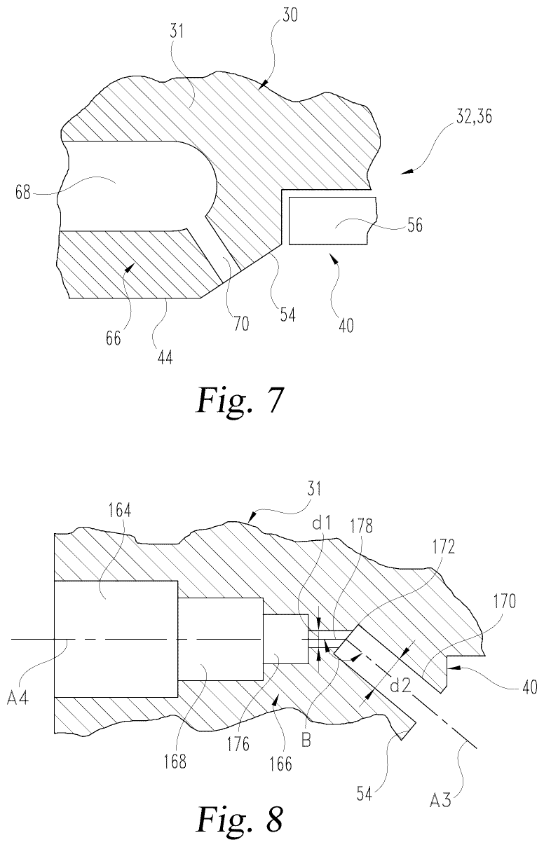

Sensor port 60 includes housing portion 64 and passage portion 66 that provides a fluid connection of combustion chamber 14 to the in-cylinder pressure sensor 62 housed in housing portion 64 of sensor port 60. Passage portion 66 opens at the combustion side 44 of cylinder head body 31, such as at the valve relief cut 54. In an embodiment, the valve relief cut 54 is a chamfer or sloped surface in combustion side 44 of cylinder head 30 that associated with a valve seat 40, but embodiments without a valve seat 40 and/or valve seat insert 56 are also contemplated. In an embodiment, valve relief cut is flared outwardly toward combustion chamber 14, such as shown further in FIG. 7.

Passage portion 66 may include multiple passage portions, such as first passage portion 68 and at least one second passage portion 70 in the illustrated embodiment. Housing portion 64 and first passage portion 68 extend into cylinder head body 31 along a second longitudinal axis A2 from a sidewall 50 of cylinder head body 31. In an embodiment, housing portion 64 extends collinearly to first passage portion 68 of sensor port 60. The at least one second passage portion 70 extends noncollinearly to first passage portion 68 and extends along a third longitudinal axis A3 that forms an oblique angle B with second longitudinal axis A2.

In an embodiment, second passage portion 70 is obliquely oriented to first passage portion 68. In other embodiments, second passage portion 70 is orthogonal to first passage portion 68, and or two or more noncollinear second passage portions 70 are provided. In an embodiment, each passage portion 68, 70 is straight. However, non-straight configurations for one or both of passage portions 68, 70 are not precluded.

In an embodiment, first passage portion 68 includes a first cross-sectional area and/or dimension d1 orthogonal to second longitudinal axis A2. Second passage portion 70 includes a second cross-sectional area and/or dimension d2 orthogonal to third longitudinal axis A3. In an embodiment, the second cross-sectional area and/or dimension d2 is less than the first cross-sectional area and/or dimension d1. In embodiments in which first and second passage portions 68, 70 are circular in cross-section, dimensions d1 and d2 are diameters of respective ones of the first and second passage portions 68, 70. Other embodiments contemplate non-circular cross-sections for first and/or second passage portions 68, 70.

In another embodiment, the second cross-sectional area and/or dimension d2 is the same as the first cross-sectional area and/or dimension d1. In still another embodiment, the second cross-sectional area and/or dimension d2 is greater than the first cross-sectional area and/or dimension d1.

In an embodiment, housing portion 64 includes a first length L1 along second longitudinal axis A2 from sidewall 50 to first passage portion 68. First length L1 can vary depending on the configuration or length of the in-cylinder pressure sensor 62 to be installed in housing portion 64. In addition, housing portion 64 can be formed with multiple sections or regions of different sizes and/or configurations to accommodate the size and shape of the in-cylinder pressure sensor 62 to be installed. The passage portion 66 disclosed herein can thus be employed with any configuration of in-cylinder pressure sensor 62 by shortening or lengthening passage portion 66 based on the form factor of the in-cylinder pressure sensor to be installed.

First passage portion 68 includes a second length L2 that extends along second longitudinal axis A2 from housing portion 64 into cylinder head body 31. Second passage portion 70 includes a third length L3 extending along third longitudinal axis A3 from first passage portion 68 to an opening at combustion side 44 of cylinder head body 31. In an embodiment, first passage portion 68 extends to a spherically shaped end wall 72, and second passage portion 70 intersects the spherically shaped end wall 72. In an embodiment, spherically shaped end wall 72 is concavely curved into cylinder head body and is shaped to define a portion of a sphere.

The spherically shaped end wall 72 prevents additional stress concentrators in cylinder head body 31 that may be created due to the formation of the intersecting passage portions 68, 70 by a compound angle machining process. In an embodiment, length L2 of first passage portion 68 is greater than length L3 of second passage portion 70 to aid in manufacturing and allow the use of a wider drill bit which is less prone to wander during drilling over longer distances.

Other embodiments contemplate other configurations at end wall 72 for reducing stress concentrations which do not include a spherical shape. For example, a standard drill point with a large radius between the conical end and the cylindrical face can be employed to form end wall 72. In another example, a flat bottom drill with a large radius between the bottom and the cylindrical face can be employed to form end wall 72. Other stress reducing configurations are also contemplated and not precluded.

In an embodiment, second passage portion 70 opens on valve relief cut 54. In a particular embodiment, second passage portion 70 opens on valve relief cut 54 which is downstream of a valve seat insert 56 and provides a lead-in for placement of valve seat insert 56 for valve seat 40. In the closed position, intake valve 38 (or exhaust valve) contacts valve seat insert 56 but does not obstruct the opening of second passage portion 70 on valve relief cut 54. The smaller cross-sectional area and/or dimension d2 of second passage portion 70 allows for the drilling of second passage portion 70 to be placed through valve relief cut 54 at combustion side 44 of cylinder head body 31.

The second passage portion 70 opening at valve relief cut 54 allows the opening for in-cylinder pressure sensing to be placed at the nearest “clear space” in the cylinder 12, minimizing the overall length of the passage portion 66 and maximizing the acoustic resonance frequency of the passage portions. In contrast, lower acoustic resonance frequencies may occur at other potential sensing locations in the cylinder 12 due to being placed further away from the sensor housing, which may interfere with and obscure the pressure signals that the in-cylinder pressure sensor 62 is supposed to measure. In addition, the opening at valve relief cut 54 positions the sensing passage portion 66 of the in-cylinder pressure sensor 62 as close as possible to the optimal pressure sensing location nearer the centerline of intake valve 38 (or exhaust valve) and away from the liner or edge of the cylinder 12.

Referring to FIG. 4, an embodiment of a portion of a manifold is shown, such as intake manifold 16 or exhaust manifold 18. Manifold 16, 18 is engaged to sidewall 50 of cylinder head 30. Manifold 16, 18 includes an end wall 80 that extends along cylinder head 30. End wall 80 includes a plurality of slots 82. Each slot 82 extends into the end wall 80 around aligned ones of the sensor ports 60. Slot 82 provides access to the in-cylinder pressure sensor 62 in the corresponding sensor port 60, and provides a path for sensor cable 63 to pass.

In an embodiment, the slots 82 are each U-shaped and open along one side thereof. Slots 82 allow for the corresponding in-cylinder pressure sensor 62 to be accessed straight-on during servicing with minimal removal of exterior engine components to access the in-cylinder pressure sensors 62. In addition, manifold 16, 18 can be removed without disturbing or removing the in-cylinder pressure sensors 62 or its sensor cable 63, providing advantageous capabilities during cleaning, servicing, and diagnostics.

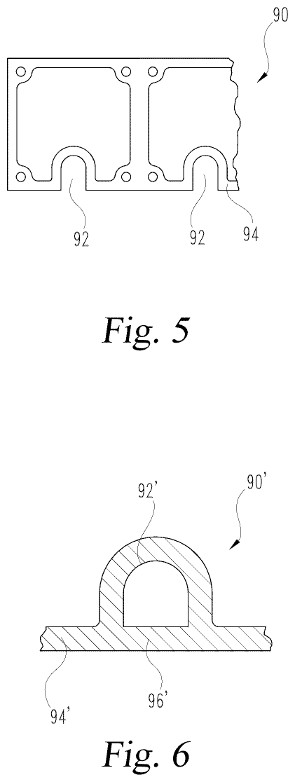

Referring to FIG. 5, an embodiment of a portion of a manifold gasket 90 is shown that is engageable between intake manifold 16 or exhaust manifold 18 and sidewall 50 of cylinder head body 31. Manifold gasket 90 includes a lower side 94 with a plurality of second slots 92 that align with slots 82 of manifold 16, 18 and align with sensor ports 60. Manifold gasket 90 is thus also configured to accommodate the sensor ports 60 of cylinder head 30.

In an embodiment, the slots 92 are each U-shaped and open along one side thereof. Slots 92 allow for the corresponding in-cylinder pressure sensor 62 to be accessed straight-on during servicing with minimal removal of exterior engine components to access the in-cylinder pressure sensors 62. In addition, manifold gasket 90 can be removed without disturbing or removing the in-cylinder pressure sensors 62 or its sensor cable 63, providing advantageous capabilities during cleaning, servicing, and diagnostics.

Since prior manifolds did not include slots 82, and since this area was occupied by manifold material, manifold gasket 90 is backwards compatible with cylinder heads and manifolds that are not configured with sensor ports 60 and slots 82. As a result, the same gasket 90 can be used regardless of whether the cylinder head is equipped with the sensor ports 60. The number of parts is therefore reduced, and the potential for the wrong manifold gasket to be fitted to the cylinder head during assembly and/or servicing is reduced.

Referring to FIG. 6, another embodiment manifold gasket 90′ is shown that is similar to manifold gasket 90. However, manifold gasket 90′ includes a cross-member 96′ aligned with the end wall 94′ of the manifold gasket 90′. A cross-member 96′ extends across each of the slots 92′ to provide increased stiffness for manifold gasket 90′ as compared to manifold gasket 90 having open-sided slots 92.

Referring to FIGS. 8-10, further embodiments of sensor port 60 for housing the in-cylinder pressure sensor 62 are shown. The sensor ports 160, 160′ of the embodiments of FIGS. 8-10 include one or more configurations that attenuate acoustic ringing detected by the in-cylinder pressure sensor 62 caused by resonance in the passage portion, and/or to increase the resonance frequency. This differentiates the acoustic frequency of the sensor port 160, 160′ from the signals measured by in-cylinder pressure sensor 62 to enhance the ability of in-cylinder pressure sensor 62 to measure in-cylinder pressure. For example, increasing the acoustic frequency of the sensor port 160, 160′ better differentiates the sensor port acoustic frequency from the signals measured by in-cylinder pressure sensor 62, mitigating or reducing interference with the frequency range of the in-cylinder pressure signal that in-cylinder pressure sensor 62 is attempting to measure. It should be understood that while different configurations for the acoustic frequency increasing geometries are shown in FIGS. 8-10, two or more of these geometries could be combined in a sensor port 160, 160′ configured according to the present disclosure.

Referring to FIG. 8, an embodiment of an acoustic frequency increasing sensor port is shown and designated as sensor port 160. Sensor port 160 includes a housing portion 164 and a passage portion 166 that provides a fluid connection of combustion chamber 14 to the in-cylinder pressure sensor 62 housed in housing portion 164 of sensor port 160. Passage portion 166 opens at the combustion side 44 of cylinder head body 31 in any manner and/or location similar to that discussed above for sensor port 60.

Passage portion 166 may include multiple passage portions, such as first passage portion 168 and at least one second passage portion 170. In an embodiment, first passage portion 168 includes at least one transition passage portion 174 extends to second passage portion 170. In the illustrated embodiment, the at least one transition passage portion 174 includes a first transition passage portion 176 and a second transition passage portion 178. Housing portion 164, first passage portion 168, and first and second transition passage portions 176, 178 extend into cylinder head body 31 along a second longitudinal axis A2 from a sidewall 50 of cylinder head body 31.

In an embodiment, housing portion 164 extends collinearly to first passage portion 168, first transition passage portion 176, and second transition passage portion 178 of sensor port 160. The at least one second passage portion 170 extends non-collinearly from the at least one transition passage portion 174 along a third longitudinal axis A3 that forms an oblique angle B with second longitudinal axis A2. In another embodiment, second passage portion 170 is collinear with transition passage portion 174.

In an embodiment, each of the first and second transition passage portions 176, 178 is obliquely oriented to the at least one second passage portion 170. In other embodiments, second passage portion 170 is orthogonal to first passage portion 168 and/or the at least one transition passage portion 174. Other embodiments contemplate two or more noncollinear second passage portions 170 are provided, such as offset passage portions where the center lines of the passages do not intersect one another and/or are parallel to one another. In an embodiment, each passage portion 168, 170, 176, 178 is straight. However, non-straight configurations for one or more of passage portions 168, 170, 176, 178 are not precluded, such as one or more of passage portions 168, 170, 176, 178 including a curved configuration along all or part of its length.

In an embodiment, the at least one transition passage portion 174 of first passage portion 168 includes a first cross-sectional area and/or dimension d1 orthogonal to second longitudinal axis A2. In an embodiment, second transition passage portion 178 includes cross-sectional area and/or dimension d1, and first transition passage portion 176 includes a greater cross-sectional area and/or dimension than second transition passage portion 178. In an embodiment, first passage portion 168 includes a greater cross-sectional area and/or dimension adjacent to and extending from housing portion 164 than first transition passage portion 176. Second passage portion 170 includes a second cross-sectional area and/or dimension d2 orthogonal to third longitudinal axis A3.

In an embodiment, first passage portion 168 includes a cross-sectional dimension that is greater than or equal to the cross-sectional dimension of first transition portion 176 and/or second transition portion 178. In an embodiment, first passage portion 168 includes a cross-sectional dimension that is less than or equal to the cross-sectional dimension of first transition portion 176 and/or second transition portion 178.

In an embodiment, the first cross-sectional area and/or dimension d1 is less than the second cross-sectional area and/or dimension d2 to differentiate the acoustical frequency of passage portion 166 from the range of signals to be detected by in-cylinder pressure sensor 62. In an embodiment, the ratio of d2 to d1 is greater than 1. In an embodiment, the ratio of d2 to d1 is maximized to increase the acoustic resonance frequencies of passage portion 166 outside the range of signals to be detected by in-cylinder pressure sensor 62. Other embodiments contemplate ratios of d2 to d1 that are equal to 1 or less than 1.

In embodiments in which passage portions 168, 170, 176, 178 are circular in cross-section, dimensions d1 and d2 are diameters of respective ones of the second transition passage portion 178 and second passage portion 170. Other embodiments contemplate non-circular cross-sections for one or more of passage portions 168, 170, 176, 178.

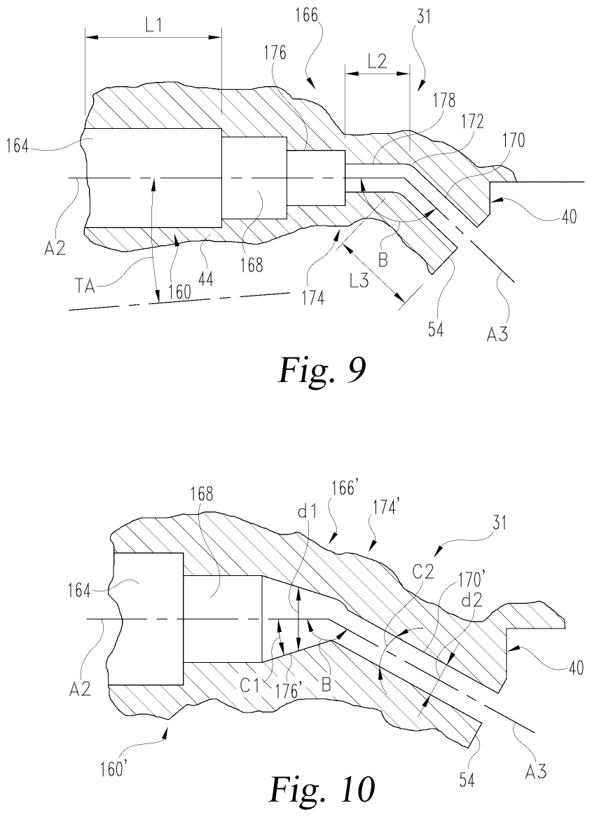

Referring to FIG. 9, a further embodiment of sensor port 160 is illustrated. In this embodiment, housing portion 164 includes a first length L1 along second longitudinal axis A2 from sidewall 50 to first passage portion 168. Housing portion 164 can be formed with multiple sections or regions of different sizes and/or configurations along first length L1 to accommodate the size and shape of the in-cylinder pressure sensor 62 to be installed. First length L1 can vary depending on the configuration or length of the in-cylinder pressure sensor 62 to be installed in housing portion 164. In an embodiment, tilt angle TA between second longitudinal axis A2 and the combustion side (fire deck) 44 of the cylinder head body 31 is selected so in-cylinder pressure sensor 62 can be inserted at a depth in cylinder head body 31 that allows a second length L2 of second transition passage portion 178 to be minimized.

Second length L2 of second transition passage portion 178 of passage portion 166 extends along second longitudinal axis A2 from second passage portion 170 toward housing portion 164. Second passage portion 170 includes a third length L3 extending along third longitudinal axis A3 from second transition passage portion 178 to an opening at combustion side 44 of cylinder head body 31.

In an embodiment, second passage portion 170 extends to a spherically shaped end wall 172, and second transition passage portion 178 intersects the spherically shaped end wall 172. In an embodiment, spherically shaped end wall 172 is concavely curved into cylinder head body and is shaped to define a portion of a sphere. Other configurations for end wall 172 are also contemplated as discussed above for end wall 72. Spherically-shaped end wall 172 allows second transition passage portion 178 to intersect second passage portion 170 without causing a breakout with sharp edges, reducing stress concentrators. The spherically-shaped end wall 172 provides stress-relief, ease of machining, and improvement in the acoustical performance of passage portion 166.

In an embodiment, length L2 of passage portion 166 such as along second transition passage portion 178 is less than length L3 of second passage portion 170 to differentiate the acoustical frequency of passage portion 166 from the range of signals to be measured by in-cylinder pressure sensor 62. In an embodiment, the ratio of L2 to L3 is less than 1. In an embodiment, the ratio of L2 to L3 is minimized to increase the acoustical frequency of passage portion 166 outside the range of signals to be detected by in-cylinder pressure sensor 62. Other embodiments contemplate ratios of L2 to L3 that are equal to 1 or greater than 1.

Referring to FIG. 10, another embodiment sensor port 160′ is shown that is similar to sensor port 160. However, sensor port 160′ includes tapered cross-sectional dimensions along the at least one transition passage portion 174′ and/or along the second passage portion 170′. The tapered passage portions increase the acoustic frequency of passage portion 166 to better differentiate from the signals to be measured by in-cylinder pressure sensor 62. The tapered passage portions also dampen the amplitude of pressure oscillations while the natural frequency of the pressure oscillations is high enough to not interfere with the ability to measure frequencies indicative of combustion performance. For example, there is a gain that is a function of the frequency, and the gain is greater than 1 near the resonance. The tapered passage portions are configured to reduce the gain and make the gain as small as possible.

In the illustrated embodiment, a single transition passage portion 176′ is provided between first passage portion 168 and second passage portion 170′. Transition passage portion 176′ includes a cross-sectional area or dimension d1 that tapers at a taper angle C1 from first passage portion 168 to second passage portion 170′. Second passage portion 170′ includes a second cross-sectional area of dimension d2 that tapers at a taper angle C2 from its opening at combustion side 44 to transition passage portion 176′. Other embodiments contemplate that transition passage portion 176′ tapers away from second passage portion 170′ and/or second passage portion 170′ tapers away from transition passage portion 176′.

In the illustrated embodiment, the cross-sectional area and/or dimensions d1 and d2 are tapered along the entire length of the respective passage portion. Other embodiments contemplate the tapered dimensions extend along less than the entire length of the respective passage portion. Still other embodiments contemplate multiple passage portion extending from a single housing portion to fluidly connect combustion chamber 14 to the in-cylinder pressure sensor 62.

The sensor ports 60, 160, 160′ disclosed herein can be made by any suitable technique. For example, cylinder head 30 can be fabricated by three-dimensional printing to include the sensor ports 60, 160, 160′. Other embodiments contemplate that sensor ports 60, 160, 160′ are cast in place with cylinder head 30, and/or are configured within cylinder head 30 so as to be able to be formed with appropriate tooling.

Many aspects of the present disclosure are envisioned. For example, one aspect is directed to an internal combustion engine configured for in-cylinder pressure sensing. The internal combustion engine includes at least one cylinder including a combustion chamber for receiving a charge flow and fuel for combustion in the combustion chamber. The internal combustion engine also includes a cylinder head mounted to the at least one cylinder. The cylinder head includes an opening to provide the charge flow to the combustion chamber through the opening or receive exhaust flow from the combustion chamber. The cylinder head also includes a valve relief cut extending around the opening and a sensor port for housing an in-cylinder pressure sensor in fluid communication with the combustion chamber. The sensor port includes a housing portion for housing the in-cylinder pressure sensor and a passage portion that extends from the valve relief cut to the housing portion to fluidly connect the in-cylinder pressure sensor housed in the housing portion with the combustion chamber.

In an embodiment, the valve seat includes a valve seat insert mounted in the cylinder head and the valve relief cut extends from the valve seat insert toward the combustion chamber. The passage portion opens into the combustion chamber at the valve relief cut.

In a further embodiment, the valve relief cut is outwardly flared toward the combustion chamber.

In an embodiment, a manifold is mounted to the cylinder head. The manifold is configured to provide the charge flow to the cylinder head or receive exhaust flow from the cylinder.

In a further embodiment, the manifold includes an end wall that extends along the cylinder head and a slot that extends into the end wall around the sensor port. The slot provides access of the in-cylinder pressure sensor in the sensor port.

In a further embodiment, a manifold gasket is provided between the cylinder head and the manifold. The manifold gasket includes a second slot that aligns with the slot of the manifold.

In a further embodiment, the manifold gasket includes a cross-member aligned with the end wall of the manifold, the cross-member extending across the second slot.

In an embodiment, the passage portion of the sensor port includes a first passage portion extending from the housing portion toward the combustion chamber. The passage portion also includes a second passage portion obliquely oriented to the first passage portion. The second passage portion extends from the first passage portion to the valve relief cut.

In a further embodiment, the first passage portion includes a first cross-sectional area. The second passage portion includes a second cross-sectional area that is less than the first cross-sectional area.

In an embodiment, the housing portion is axially aligned with the first passage portion.

According to another aspect of the present disclosure, a cylinder head for a cylinder of an internal combustion engine is provided. The cylinder head includes a cylinder head body that includes a combustion side toward the cylinder. The cylinder head body further includes a sensor port. The sensor port includes a housing portion configured to house an in-cylinder pressure sensor, a first passage portion that extends from the housing portion into the cylinder head body, and at least one second passage portion that extends noncollinearly to the first passage portion to the combustion side of the cylinder head.

In an embodiment, the first passage portion is co-linear with the housing portion.

In an embodiment, the first passage portion is straight and the at least one second passage portion is straight.

In an embodiment, the first passage portion is longer than the at least one second passage portion.

In an embodiment, the first passage portion includes a first cross-sectional dimension. The at least one second passage portion includes a second cross-sectional dimension that is less than the first cross-sectional dimension.

In an embodiment, the first passage portion extends from the housing portion to a spherically-shaped end wall. The at least one second passage portion intersects the spherically-shaped end wall.

In an embodiment, the at least one opening in the combustion side of the cylinder head includes a valve relief cut. The at least one second passage portion opens on the valve relief cut.

In an embodiment, the cylinder head body includes a sidewall to which a manifold is mounted. The housing portion of the sensor port opens at the sidewall of the cylinder head body.

In an embodiment, the first passage portion and the at least one second passage portion each include a circular cross-section. A diameter of the first passage portion is greater than a diameter of the at least one second passage portion.

In an embodiment, the at least one opening is part of an intake port formed by the cylinder head.

According to another aspect of the present disclosure, a cylinder head for a cylinder of an internal combustion engine is disclosed. The cylinder head includes a cylinder head body that includes a combustion side toward the cylinder and a sensor port for an in-cylinder pressure sensor. The sensor port includes a housing portion configured to house the in-cylinder pressure sensor and a passage portion that extends from the housing portion to the combustion side of the cylinder head. The passage portion is configured to attenuate acoustic ringing from resonance in the passage portion

According to another aspect of the present disclosure, a cylinder head for a cylinder of an internal combustion engine is provided. The cylinder head includes a cylinder head body that includes a combustion side toward the cylinder. The cylinder head body further includes a sensor port for an in-cylinder pressure sensor. The sensor port includes a housing portion configured to house the in-cylinder pressure sensor and a passage portion that extends from the housing portion to the combustion side of the cylinder head. The passage portion is configured to increase resonance frequency.

In an embodiment, the passage portion is a single passage extending from the housing portion to the combustion chamber.

In an embodiment, the passage portion includes a first passage portion extending from the housing portion into the cylinder head, a second passage portion that extends from the combustion side of the cylinder head into the cylinder head. The first passage portion includes at least one transition passage portion that connects the first passage portion to the second passage portion. The first passage portion, the second passage portion, and the at least one transition passage portion are configured to differentiate an acoustic frequency of the passage portion from signals detected by the in-cylinder pressure sensor.

In an embodiment, the first passage portion includes a first cross-sectional dimension, the second passage portion includes a second cross-sectional dimension, and a ratio of the second cross-sectional dimension to the first cross-sectional dimension is not equal to 1.

Further embodiments contemplate ratios for the second cross-sectional dimension to the first cross-sectional dimension that are equal to 1, more than 1, or less than 1.

In an embodiment, the first passage portion extends along a first axis and includes a first length along the first axis, the second passage portion extends along a second axis and includes a second length along the second axis, and a ratio of the first length to the second length is not equal to 1.

Further embodiments for the first length and the second length can be provided with ratios that are equal to 1, greater than 1, or less than 1.

In an embodiment, the at least one transition passage portion extends along a first axis and includes a first cross-sectional dimension that tapers along the first axis. The second passage portion extends along a second axis and includes a second cross-sectional dimension that tapers along the second axis.

In an embodiment, the at least one transition passage portion includes a first transition passage portion extending from the first passage portion toward the second passage portion. The at least one transition passage portion also includes a second transition passage portion extending from the first transition passage portion to the second passage portion.

In an embodiment, the second transition passage portion includes a first cross-sectional dimension, the second passage portion includes a second cross-sectional dimension, and a ratio of the second cross-sectional dimension to the first cross-sectional dimension is not equal to 1.

In an embodiment, the first transition passage portion includes a third cross-sectional dimension that is greater than the first cross-sectional dimension.

In an embodiment, the first transition passage portion includes a third cross-sectional dimension that is less than or equal to the first cross-sectional dimension.

In an embodiment, the first passage portion includes a fourth cross-sectional dimension that is greater than the third cross-sectional dimension.

In an embodiment, the first passage portion includes a fourth cross-sectional dimension that is less than or equal to the third cross-sectional dimension.

In an embodiment, the housing portion, the first passage portion, and the at least one transition passage portion are collinear with one another.

In an embodiment, the second passage portion is obliquely oriented to the at least one transition passage portion.

In an embodiment, the second passage portion is collinear to the at least one transition passage portion.

In an embodiment, the second passage portion is orthogonal to the at least one transition passage portion.

In an embodiment, the second passage portion is not collinear to the at least one transition passage portion.

In an embodiment, the second passage portion is offset from the at least one transition passage portion such that the second passage portion and the at least one transition passage portion include center lines that do not intersect one another and/or are parallel to one another.

In an embodiment, the second passage portion and/or the at least one transition passage portion are not straight and include a curved configuration along at least part of a length thereof.

In an embodiment, the passage portion includes at least one transition passage portion between the housing portion and a second passage portion that extends from the combustion side of the cylinder head. The at least one transition passage portion includes a first cross-sectional dimension that is less than a second cross-sectional dimension of the second passage portion, or the at least one transition passage portion includes a first length that is less than a second length of the second passage portion.

In an embodiment, the first cross-sectional dimension is less than the second cross-sectional dimension and the first length is less than the second length.

In an embodiment, the passage portion includes at least one transition passage portion between the housing portion and a second passage portion that extends from the combustion side of the cylinder head. The at least one transition passage portion includes a first cross-sectional dimension that tapers, or the second passage portion includes a second cross-sectional dimension that tapers.

In an embodiment, at least one of the at least one transition passage portion and the second passage portion are tapered.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1-10. (canceled)

11. A cylinder head for a cylinder of an internal combustion engine, the cylinder head comprising:
a cylinder head body that includes a combustion side toward the cylinder, the cylinder head body further including a sensor port for an in-cylinder pressure sensor, the sensor port including:
a housing portion configured to house the in-cylinder pressure sensor;
a first passage portion that extends from the housing portion into the cylinder head; and
at least one second passage portion that extends noncollinearly to the first passage portion to the combustion side of the cylinder head.

12-20. (canceled)

21. A cylinder head for a cylinder of an internal combustion engine, the cylinder head comprising:
a cylinder head body that includes a combustion side toward the cylinder, the cylinder head body further including a sensor port for an in-cylinder pressure sensor, the sensor port including:
a housing portion configured to house the in-cylinder pressure sensor;
a passage portion that extends from the housing portion to the combustion side of the cylinder head, wherein the passage portion is configured to attenuate acoustic ringing from resonance in the passage portion.

22. The cylinder head of claim 21, wherein the passage portion is a single passage extending from the housing portion to the combustion chamber.

23. The cylinder head of claim 21, wherein the passage portion includes:
a first passage portion extending from the housing portion into the cylinder head; and
a second passage portion that extends from the combustion side of the cylinder head into the cylinder head; and
the first passage portion includes at least one transition passage portion that connects the first passage portion to the second passage portion, the first passage portion, the second passage portion, and the at least one transition passage portion being configured to attenuate acoustic ringing detected by the in-cylinder pressure sensor that is caused by resonance in the passage portion.

24. The cylinder head of claim 23, wherein:
the first passage portion includes a first cross-sectional dimension;
the second passage portion includes a second cross-sectional dimension; and
a ratio of the second cross-sectional dimension to the first cross-sectional dimension is more than 1.

25. The cylinder head of claim 23, wherein:
the first passage portion extends along a first axis and includes a first length along the first axis;
the second passage portion extends along a second axis and includes a second length along the second axis; and
a ratio of the first length to the second length is less than 1.

26. The cylinder head of claim 23, wherein:
the at least one transition passage portion extends along a first axis, the at least one transition passage portion including a first cross-sectional dimension that tapers along the first axis; and
the second passage portion extends along a second axis, the second passage portion including a second cross-sectional dimension that tapers along the second axis.

27. The cylinder head of claim 23, wherein the at least one transition passage portion includes:
a first transition passage portion extending from the first passage portion toward the second passage portion; and
a second transition passage portion extending from the first transition passage portion to the second passage portion.

28. The cylinder head of claim 27, wherein:
the second transition passage portion includes a first cross-sectional dimension;
the second passage portion includes a second cross-sectional dimension; and
a ratio of the second cross-sectional dimension to the first cross-sectional dimension is not equal to 1.

29. The cylinder head of claim 28, wherein the first transition passage portion includes a third cross-sectional dimension that is greater than the first cross-sectional dimension.

30. The cylinder head of claim 28, wherein the first transition passage portion includes a third cross-sectional dimension that is less than or equal to the first cross-sectional dimension.

31-32. (canceled)

33. The cylinder head of claim 23, wherein the housing portion, the first passage portion, and the at least one transition passage portion are collinear with one another.

34. The cylinder head of claim 23, wherein the second passage portion is obliquely oriented to the at least one transition passage portion.

35. The cylinder head of claim 23, wherein the second passage portion is collinear to the at least one transition passage portion.

36. The cylinder head of claim 23, wherein the second passage portion is orthogonal to the at least one transition passage portion.

37. The cylinder head of claim 23, wherein the second passage portion is offset from the at least one transition passage portion.

38. The cylinder head of claim 21, wherein the passage portion includes at least one transition passage portion between the housing portion and a second passage portion, the second passage portion extending from the combustion side of the cylinder head, wherein:
the at least one transition passage portion includes a first cross-sectional dimension that is less than a second cross-sectional dimension of the second passage portion; or
the at least one transition passage portion includes a first length that is less than a second length of the second passage portion.

39. (canceled)

40. The cylinder head of claim 21, wherein the passage portion includes at least one transition passage portion between the housing portion and a second passage portion, the second passage portion extending from the combustion side of the cylinder head, wherein:
the at least one transition passage portion includes a first cross-sectional dimension that tapers; or
the second passage portion includes a second cross-sectional dimension that tapers.

41. The cylinder head of claim 40, wherein at least one of the at least one transition passage portion and the second passage portion are tapered.

42. A cylinder head for a cylinder of an internal combustion engine, the cylinder head comprising:
a cylinder head body that includes a combustion side toward the cylinder, the cylinder head body further including a sensor port for an in-cylinder pressure sensor, the sensor port including:
a housing portion configured to house the in-cylinder pressure sensor;
a passage portion that extends from the housing portion to the combustion side of the cylinder head, wherein the passage portion is configured to increase resonance frequency.

43. (canceled)
